(19) United States
(12) Patent Application Publication
(10) Pub. No.: US 2014/0019789 A1
(43) Pub. Date: Jan. 16, 2014

(54) MONITORING A BATTERY IN AN ELECTRONIC DEVICE

(71) Applicants: Ramesh C. Bhardwaj, Fremont, CA (US); Sheba Devan, Santa Clara, CA (US); Richard M. Mank, Cupertino, CA (US)

(72) Inventors: Ramesh C. Bhardwaj, Fremont, CA (US); Sheba Devan, Santa Clara, CA (US); Richard M. Mank, Cupertino, CA (US)

(73) Assignee: APPLE INC., Cupertino, CA (US)

(21) Appl. No.: 13/545,267

(22) Filed: Jul. 10, 2012

(51) Int. Cl. G06F 11/30; G06F 1/26; H02J 7/00

(52) U.S. Cl. 713/340

(57) ABSTRACT

A method and apparatus are described for monitoring a battery in an electronic device. In the described embodiments, a discharge current pulse is applied to a battery and the voltage change of the battery due to the discharge current pulse is determined. The impedance of the battery is then determined based on the voltage change and the discharge current pulse. An alert is then selectively generated based on the impedance.

### BACKGROUND

1. Field

The described embodiments relate to techniques for monitoring a battery in an electronic device. More specifically, the described embodiments relate to techniques for monitoring the battery by measuring an impedance of the battery.

2. Related Art

Rechargeable batteries powering electronic devices such as laptop computers, smartphones, and tablet computers are often designed to have a life under normal use conditions of 500 to 1000 recharging cycles. However, if the electronic device is damaged, for example by being dropped or having something fall on it, the rechargeable battery may also be damaged and this may shorten the useful life of the battery. A damaged or defective battery may experience delamination of one or more of the cells in the battery or other internal defects that may eventually lead to undesirable swelling and/or excessive heating of the battery, resulting in a detrimental impact on battery life and possibly even battery safety.

Hence, use of electronic devices may be facilitated by monitoring a battery powering the electrical device.

### BRIEF DESCRIPTION OF THE FIGURES

FIG. 1 presents a block diagram illustrating an electronic device in accordance with the described embodiments.

FIG. 2 presents a block diagram illustrating a battery management unit in accordance with the described embodiments.

FIG. 3 presents a flowchart illustrating a process for monitoring a battery in an electronic device in accordance with the described embodiments.

FIG. 4 presents an exemplary graph illustrating impedance vs. recharge cycle number for one undamaged and two damaged batteries in accordance with the described embodiments.

In the figures, like reference numerals refer to the same figure elements.

### DETAILED DESCRIPTION

The following description is presented to enable any person skilled in the art to make and use the described embodiments, and is provided in the context of a particular application and its requirements. Various modifications to the described embodiments will be readily apparent to those skilled in the art, and the general principles defined herein may be applied to other embodiments and applications without departing from the spirit and scope of the described embodiments. Thus, the described embodiments are not limited to the embodiments shown, but are to be accorded the widest scope consistent with the principles and features disclosed herein.

The data structures and code described in this detailed description are typically stored on a computer-readable storage medium, which may be any device or medium that can store code and/or data for use by an electronic device and/or battery management unit with computing capabilities. For example, the computer-readable storage medium can include volatile memory or non-volatile memory, including flash memory, random access memory (RAM, SRAM, DRAM, RDRAM, DDR/DDR2/DDR3 SDRAM, etc.), magnetic or optical storage mediums (e.g., disk drives, magnetic tape, CDs, DVDs), or other mediums capable of storing data structures or code. Note that, in the described embodiments, the computer-readable storage medium does not include non-statutory computer-readable storage mediums such as transmission signals.

The methods and processes described in this detailed description can be included in hardware modules. For example, the hardware modules can include, but are not limited to one or more, application-specific integrated circuit (ASIC) chips, field-programmable gate arrays (FPGAs), other programmable-logic devices, and microcontrollers. When the hardware modules are activated, the hardware modules perform the methods and processes included within the hardware modules. In some embodiments, the hardware modules include one or more general-purpose circuits that are configured by executing instructions (program code, firmware, etc.) to perform the methods and processes.

The methods and processes described in the detailed description section can be embodied as code and/or data that can be stored in a computer-readable storage medium as described above. When a battery management unit with computing capabilities reads and executes the code and/or data stored on the computer-readable storage medium, the battery management unit performs the methods and processes embodied as data structures and code and stored within the computer-readable storage medium. For example, in some embodiments, a processing subsystem in the battery management unit can read the code and/or data from a memory subsystem in the battery management unit that comprises a computer-readable storage medium and can execute code and/or use the data to perform the methods and processes.

In the following description, we refer to “some embodiments.” Note that “some embodiments” describes a subset of all of the possible embodiments, but does not always specify the same subset of embodiments.

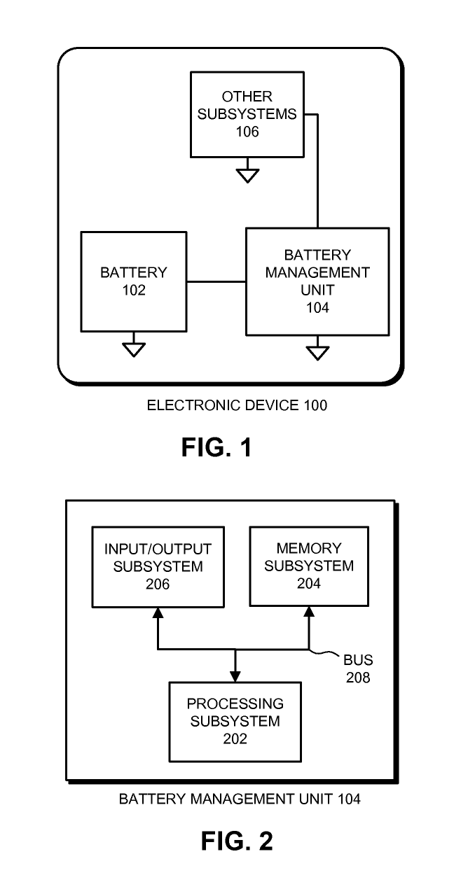

FIG. 1 presents a block diagram illustrating an electronic device in accordance with the described embodiments. Electronic device 100 includes battery 102 coupled through battery management unit (BMU) 104 to other subsystems 106.

Electronic device 100 can be (or can be included in) any device that includes a rechargeable battery. For example, electronic device 100 can be (or can be included in) a laptop computer, an appliance, a subnotebook/netbook, a tablet computer, a cellular phone, a personal digital assistant (PDA), a smartphone, or another device.

Battery 102 may be any rechargeable battery or battery system including one or more batteries and/or battery cells coupled together in any parallel or series configuration to output any desired voltage and/or current. Battery 102 may be implemented in any rechargeable battery chemistry, including but not limited to nickel metal hydride (NiMH), lithium polymer, and lithium ion battery chemistries.

BMU 104 may be any battery management unit implemented in any technology and may include any combination of hardware and software, and digital and analog circuitry. BMU 104 may include one or more microcontrollers and/or other hardware modules, and may be implemented on one or more integrated circuits. BMU 104 will be discussed in more detail with reference to FIG. 2 below.

Other subsystems 106 represents all of the other subsystems that may be present in electronic device 100 and may include but is not limited to one or more processing subsystems (e.g., CPUs), memory subsystems (e.g., volatile and non-volatile), communications subsystems, display subsystems, data collection subsystems, audio and/or video subsystems, alarm subsystems, media processing subsystems, and/or input/output (I/O) subsystems. Note that one or more of the subsystems in other subsystems 106 may be powered by battery 102.

FIG. 2 presents a block diagram illustrating a battery management unit in accordance with the described embodiments. BMU 104 includes processing subsystem 202, memory subsystem 204, and I/O subsystem 206 all coupled to bus 208.

Processing subsystem 202 includes one or more devices configured to perform computational operations. For example, processing subsystem 202 can include one or more central processing units (CPUs), microprocessors, application-specific integrated circuits (ASICs), and/or programmable-logic devices.

Memory subsystem 204 includes one or more devices for storing data and/or instructions for processing subsystem 202 and input/output (I/O) subsystem 206. For example, memory subsystem 204 can include dynamic random access memory (DRAM), static random access memory (SRAM), read only memory (ROM), erasable programmable read only memory (EPROM), flash memory, and/or other types of memory. In addition, memory subsystem 204 can include firmware and mechanisms for controlling access to the memory.

I/O subsystem 206 is a subsystem that includes input and output subsystems for inputting and outputting digital and analog signals to and from BMU 104. For example, I/O subsystem 206 may include one or more digital and/or analog programmable input and output ports and analog-to-digital input ports. Processing subsystem 202 uses I/O subsystem 206 to communicate with battery 102 and other subsystems 106. Additionally I/O subsystem 206 may include ports to control and/or measure the current and/or voltage flowing into battery 102 (e.g., to charge battery 102 using a power adapter, not shown) and the current and/or voltage flowing out of battery 102.

Processing subsystem 202, memory subsystem 204, and I/O subsystem 206 are coupled together using bus 208. Bus 208 is an electrical, optical, or electro-optical connection that the subsystems can use to communicate commands and data among one another. Although only one bus 208 is shown for clarity, different embodiments can include a different number or configuration of electrical or other connections among the subsystems.

Although shown as separate subsystems in FIG. 2, in some embodiments, some or all of a given subsystem can be integrated into one or more of the other subsystems in BMU 104. Although alternative embodiments can be configured in this way, for clarity we describe the subsystems separately.

Although we use specific subsystems to describe BMU 104, in alternative embodiments, different subsystems may be present in BMU 104. For example, BMU 104 may include one or more additional processing subsystems 202, memory subsystems 204, and/or I/O subsystems 206. Additionally, one or more of the subsystems may not be present in BMU 104. Moreover, in some embodiments, BMU 104 may include one or more additional subsystems that are not shown in FIG. 2.

Those skilled in the art will appreciate that the functionality of BMU 104 may be implemented in multiple ways. For example, BMU 104 may be implemented using one or more hardware modules (e.g., microcontrollers and/or other integrated circuits) in electronic device 100. Similarly, a portion of the functionality of BMU 104 may be implemented in software that executes on a processor of electronic device 100, and/or combinations of in-situ hardware and/or software components in electronic device 100.

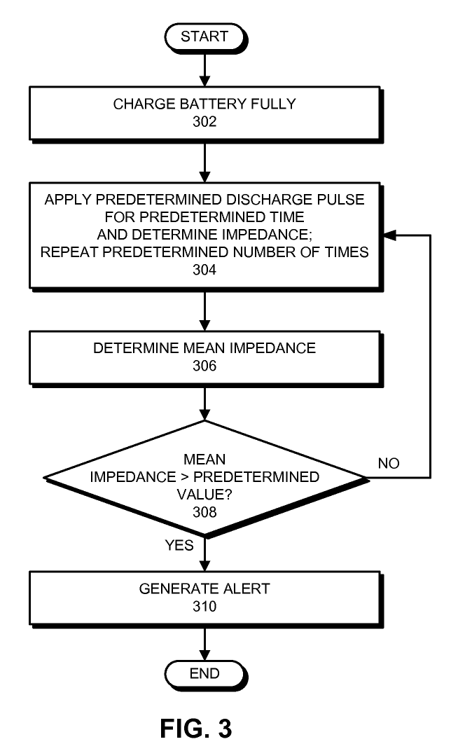

The operation of BMU 104 will be described with reference to FIG. 3 which presents a flowchart illustrating a process for monitoring a battery in an electronic device in accordance with the described embodiments. In step 302 BMU 104 charges battery 102. In some embodiments, a power adapter (not shown) provides power to electronic device 100 and BMU 104 charges battery 102 using the electrical power provided by the adapter. BMU 104 may charge battery 102 using a constant current/constant voltage charging process.

After battery 102 is fully charged (step 302), then at step 304 BMU 104 will determine the impedance of battery 102. BMU 104 may determine the impedance of battery 102 by first measuring the voltage of battery 102 (V1), then applying a predetermined discharge current pulse to battery 102 (I) for a predetermined time and measuring the voltage of battery 102 again (V2). The impedance of battery 102 (R) is then determined by subtracting the second voltage measurement from the first one and dividing by the discharge pulse,

R=(V1−V2)/I.

In some embodiments, the discharge current pulse is a 1 C rate current pulse for 1 second, while in other embodiments it may be in the range from 0.5 C to 10 C and the predetermined time (i.e., the duration of the pulse) may be from 0.5 seconds to 10 seconds. In some embodiments, BMU 104 applies the predetermined discharge current pulse by controlling current from battery 102 using I/O subsystem 206 to flow through a resistance of known value (e.g., in BMU 104, but not shown) for the predetermined time measured using a clock and/or timer circuitry in BMU 104. Note that the voltage of battery 102 may be measured by BMU 104 using an A/D converter in I/O subsystem 206 of BMU 104.

BMU 104 may then repeat the process for measuring the impedance of battery 102 a predetermined number of times with a predetermined time period between each measurement, while continuing to keep the battery fully charged. For example, BMU 104 may continue to “trickle charge” battery 102 during the process, and measure the impedance of battery 102 three times during step 304, once every ten minutes, using the process described above. Note that in some embodiments, the impedance may be measured only once during step 304.

Then, at step 306 BMU 104 determines the mean impedance from the measured impedance values. At step 308, if the mean impedance is not greater than a predetermined value, then the process returns to step 304. In some embodiments, BMU 104 may wait a predetermined time before implementing step 304 again, or step 304 may be implemented again only after a predetermined number of charge/discharge cycles have occurred since BMU 104 last implemented step 304. For example, at step 308, if the mean impedance is not greater than the predetermined value, then BMU 104 may not implement step 304 until battery 102 has charged and discharged for another 50 cycles or 100 cycles. In some embodiments BMU 104 may wait 10 minutes or one hour before implementing step 304 again.

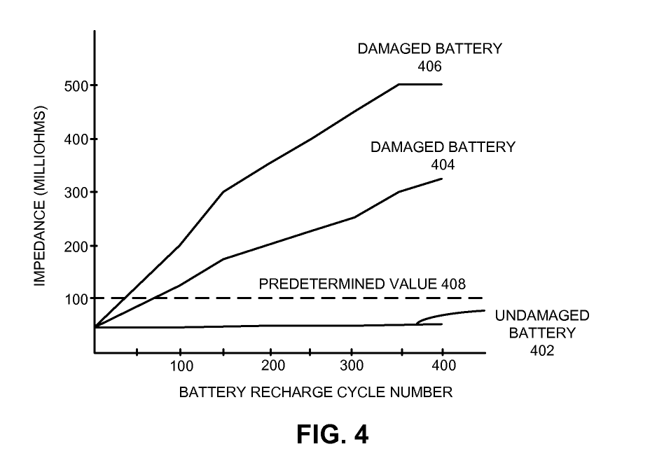

The predetermined value for step 308 may be determined using any suitable technique, including but not limited to benchtop and/or field testing of damaged/defective and undamaged batteries similar to battery 102. FIG. 4 presents an exemplary graph illustrating impedance vs. charging cycle for undamaged and damaged batteries in accordance with the described embodiments. As depicted in FIG. 4, the impedance of damaged battery 404 and damaged battery 406 both increase versus recharge cycle number much more quickly than for undamaged battery 402. Based on the data from FIG. 4, predetermined value 408 may be selected to be 100 milliohms as shown.

In some embodiments, one or more initial impedance measurements may be made of battery 102 during the assembly of electronic device 100 or as part of a pre-shipping or pre-sale calibration process. The initial measurement(s) may then be used as a baseline to determine the predetermined value based on an absolute or relative increase from the initial measurement(s). Furthermore, in some embodiments, at step 308 a slope of the impedance versus recharge cycle number may be determined, and when the slope exceeds a predetermined value, the process continues to step 310 and an alert is generated. Moreover, in some embodiments, at step 308 if BMU 104 determines that there is a non-linear increase in the slope of impedance versus recharge cycle number, then the process continues to step 310 and an alert is generated.

Note that in some embodiments BMU 104 may determine the mean impedance using fewer than all of the measured values. For example, impedance values that are determined to be “outliers” based on a predetermined absolute or relative difference with other impedance values may be excluded from the mean calculation.

At step 308, if BMU 104 determines that the mean impedance is greater than the predetermined value, then BMU 104 generates an alert and/or causes an alert to be generated (step 310) by other subsystems 106 in electronic device 100. The generated alert may include but is not limited to one or more of: a visual cue (e.g., text warning or icon), an auditory cue (e.g., a warning sound or prerecorded message), transmitting a message to the user or the manufacturer, and/or an action that may alert the user such as disconnecting battery 102, and/or preventing it from recharging.

In some embodiments, after an alert is generated at step 310 (e.g., a visual or auditory cue), BMU 104 continues to allow battery 102 to power electronic device 100, returns to step 304, and increases the predetermined value to a second predetermined value. Then, when the mean impedance exceeds the second predetermined value at step 308, at step 310 the alert generated by BMU 104 includes preventing battery 102 from being recharged and/or disconnecting battery 102, preventing it from powering electronic device 100. In some embodiments, the second predetermined value is 200 milliohms.

### Alternative Embodiments

Although the subsystems of a BMU are described as an example, in some embodiments, some or all of the above-described functions are implemented using different mechanisms. For example, in some embodiments, one or more separate integrated circuit chips perform the indicated operations. In these embodiments, the integrated circuit chips can include specialized circuits that implement some or all of the above-described operations, and/or can include general-purpose circuits that execute program code (e.g., firmware, etc.) that causes the circuits to perform the operations. In some embodiments, a combination of integrated circuit chips and a processing subsystem (not shown) in electronic device 100 is used to implement the system.

The foregoing descriptions of embodiments have been presented only for purposes of illustration and description. They are not intended to be exhaustive or to limit the embodiments to the forms disclosed. Accordingly, many modifications and variations will be apparent to practitioners skilled in the art. Additionally, the above disclosure is not intended to limit the embodiments. The scope of the embodiments is defined by the appended claims.

What is claimed is:

1. A method for monitoring a battery in an electronic device, comprising:
applying a discharge current pulse to the battery;
determining a voltage change of the battery due to the discharge current pulse;
determining an impedance based on the voltage change and the discharge current pulse; and
selectively generating an alert based on the impedance.

2. The method of claim 1, wherein:
applying the discharge current pulse to the battery includes discharging the battery with a current of at least 1 C rate for at least 1 second.

3. The method of claim 1, further comprising:
applying the discharge current pulse a predetermined number of times during a predetermined time period, wherein determining the voltage change includes determining the voltage change due to each of the predetermined number of discharge current pulses, determining the impedance includes determining the impedance based on each voltage change and discharge current pulse, and selectively generating the alert includes selectively generating the alert based on a mean of the determined impedances.

4. The method of claim 3, wherein:
the predetermined number of times is at least 3, and the predetermined time period is at least ten minutes.

5. The method of claim 1, wherein:
selectively generating the alert includes generating the alert when the impedance is greater than a predetermined impedance.

6. The method of claim 5, wherein the predetermined impedance is 100 milliohms.

7. The method of claim 1, wherein:
the alert includes displaying a visual indicator.

8. The method of claim 1, wherein applying the discharge current pulse to the battery includes applying the discharge current pulse to the battery when the battery is fully charged.

9. A system for monitoring a battery in an electronic device, comprising:
an input/output subsystem coupled to the battery; and
a processing subsystem coupled to and controlling the input/output subsystem and configured to use the input/output subsystem to apply a predetermined number of discharge current pulses to the battery during a predetermined time period, wherein for each of the predetermined number of discharge current pulses, the processing subsystem,
determines a voltage change of the battery due to the discharge current pulse;
determines an impedance based on the voltage change and the discharge current pulse; and
selectively generates an alert based on one or more of the predetermined number of determined impedances.

10. The system of claim 9, wherein the processing subsystem is configured to selectively generate the alert based on a mean of one or more of the predetermined number of determined impedances.

11. The system of claim 10, wherein the processing subsystem is configured to selectively generate the alert when the mean impedance is greater than 100 milliohms.

12. The system of claim 9, wherein the processing subsystem is configured so that each of the predetermined number of discharge current pulses includes a discharge current of at least 1 C rate for at least 1 second.

13. The system of claim 9, wherein the processing subsystem is further configured to apply the predetermined number of discharge current pulses to the battery when the battery is fully charged.

14. The system of claim 9, wherein the processing subsystem is further configured to apply the predetermined number of discharge current pulses to the battery each predetermined number of battery charging cycles.

15. A non-transitory computer-readable storage medium containing instructions that, when executed by a processing subsystem in a battery management unit, cause the battery management unit to perform a method for monitoring a battery in an electronic device, the method comprising:
applying a discharge current pulse to the battery;
determining a voltage change of the battery due to the discharge current pulse;
determining an impedance based on the voltage change and the discharge current pulse; and
selectively generating an alert based on the impedance.

16. The computer-readable storage medium of claim 15, wherein:
applying the discharge current pulse to the battery includes discharging the battery with a current of at least 1 C rate for at least 1 second.

17. The computer-readable storage medium of claim 15, wherein:
selectively generating the alert includes generating the alert when the impedance is greater than a predetermined impedance.

18. The computer-readable storage medium of claim 17, wherein the predetermined impedance is 100 milliohms.

19. The computer-readable storage medium of claim 15, wherein:
the alert includes displaying a visual indicator.

20. The computer-readable storage medium of claim 15, wherein applying the discharge current pulse to the battery includes applying the discharge current pulse to the battery when the battery is fully charged.
